(19) United States
(12) Patent Application Publication
(10) Pub. No.: US 2007/0036651 A1
(43) Pub. Date: Feb. 15, 2007

(54) Fan and blade thereof

(75) Inventors: Sung-Wei Lee, Taoyuan Hsien (TW); Shun-Chen Chang, Taoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/493,768

(22) Filed: Jul. 27, 2006

(30) Foreign Application Priority Data
Aug. 12, 2005 (TW) 094127414

(51) Int. Cl. B64C 27/615

(52) U.S. Cl. 416/23

(57) ABSTRACT

A fan includes a frame and an impeller. The impeller is disposed in the frame and the impeller has a plurality of blades. Each blade has a wing part and a flap part, and the wing part and the flap part form a predetermined angle. A blade is also disclosed.

### BACKGROUND OF THE INVENTION

1. Field of Invention

The present invention relates to a fan and a blade thereof, and more particularly to a fan and a blade thereof with a better airflow efficiency.

2. Related Art

As shown in FIG. 1, a conventional fan 1 includes a frame 11 and an impeller 12. The frame 11 has a shell 111 and a base 112. A plurality of ribs 113 are connected between the shell 111 and the base 112. Moreover, a motor (not shown) may be disposed in the base 112. The impeller 12 has a hub 121 and a plurality of blades 122 disposed around the hub 121. The impeller 12 is disposed in the base 112 of the frame 11 via the hub 121 and is driven by the motor to rotate with respect to the base 112. Therefore, each blade 122 enforces nearby air to produce airflow.

As shown in FIG. 2, the connection line between the leading edge L and the trail edge T of each blade 122 forms an installation-angle β with the bottom surface of the impeller 12. The angle between the connection line and the airflow direction into each blade 122 (as indicated by the arrow) is defined as an attack-angle α°

In practice, the angle of the airflow entering the fan 1 changes with respect to the rotating speed of the fan 1, and then the attack-angle α is changed. Once the attack-angle α exceeds a critical angle, the airflow is separated from the surface of each blade 122, and a vortex is generated above each blade 122. In this situation, the airflow cannot be further increased even if the rotating speed of the fan 1 is raised. This is the so-called stalling phenomenon. Not only the airflow efficiency of the fan 1 cannot be enhanced, it also produces noises to waste the energy consumption of the fan 1 and the airflow efficiency is thus reduced.

It is thus imperative to provide a fan and a blade thereof to solve the above-mentioned problems.

### SUMMARY OF THE INVENTION

In view of the foregoing, the present invention provides a fan and a blade thereof to prevent the stalling phenomenon from happening and to achieve better airflow efficiency.

To achieve the above, a fan according to the present invention includes a frame and an impeller. The impeller is disposed in the frame and has a plurality of blades. Each blade has a wing part and a flap part, and the wing part and the flap part form a predetermined angle.

To achieve the above, another fan according to the present invention includes a frame and an impeller. The frame has a plurality of stationary blades. Each stationary blade has a wing part and a first flap part, and the wing part and the first flap part form a predetermined angle. The impeller is disposed in the frame.

To achieve the above, yet another fan according to the present invention includes a frame, an impeller and a protecting cover. The frame has a plurality of wing parts. The impeller is disposed in the frame. The protecting cover is connected to the frame and has a plurality of flap parts respectively corresponding to the wing parts. The flap part and the wing part form a predetermined angle.

According to the invention, a fan blade according to the present invention includes a wing part and a flap part. The flap part is connected to the wing part. The flap part and the wing part form a predetermined angle.

As mentioned above, due to the flap part is connected to the wing part, and the wing part and the flap part form a first predetermined angle. Comparing with the prior art, a fan and a blade thereof according to the present invention can enhance the airflow efficiency, prevent installing phenomenon from happening, and reduce the noises during operations. Moreover, in addition to the impeller of the fan, the structure of the wing part and the flap part can be disposed in the frame or protecting cover to enhance the airflow efficiency and the product quality.

### BRIEF DESCRIPTION OF THE DRAWINGS

The present invention will become more fully understood from the detailed description given herein below illustration only, and thus are not limitative of the present invention, and wherein:

FIG. 1 is a three-dimensional exploded view showing a conventional fan;

FIG. 2 is a schematic view showing a conventional blade;

FIG. 3 is a three-dimensional exploded view showing a fan according to a first embodiment of the present invention;

FIG. 4 is a schematic view showing another fan blade according to the first embodiment of the present invention;

FIG. 5 is another schematic view showing the fan blade according to the first embodiment of the present invention;

FIG. 6 is yet another schematic view showing the fan blade according to the first embodiment of the present invention;

FIG. 7 is a schematic view showing a frame and a protecting cover according to a second embodiment of the present invention;

FIG. 8 is another schematic view showing the frame and protecting cover according to the second embodiment of the present invention;

FIG. 9 is a schematic view showing a frame and a protecting cover according to a third embodiment of the present invention; and

FIG. 10 is the characteristic curves showing wind pressure versus wind flux of the fan according to the present invention and a conventional fan.

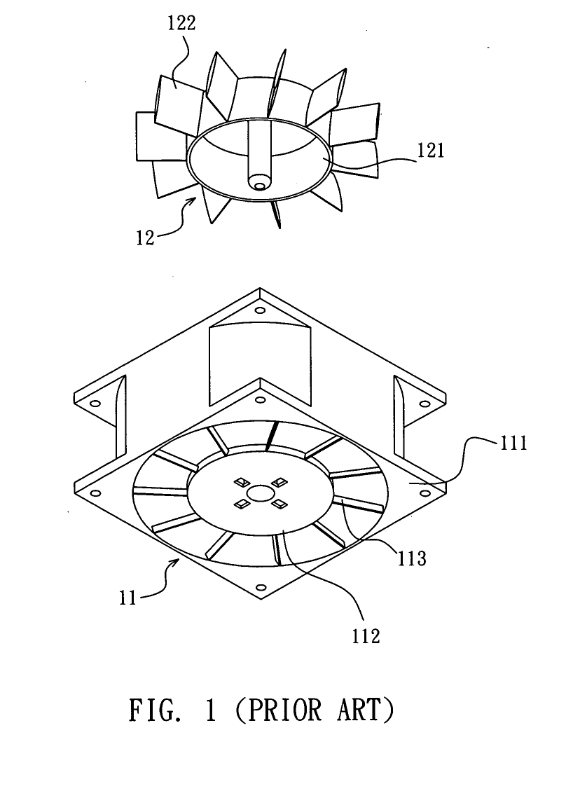

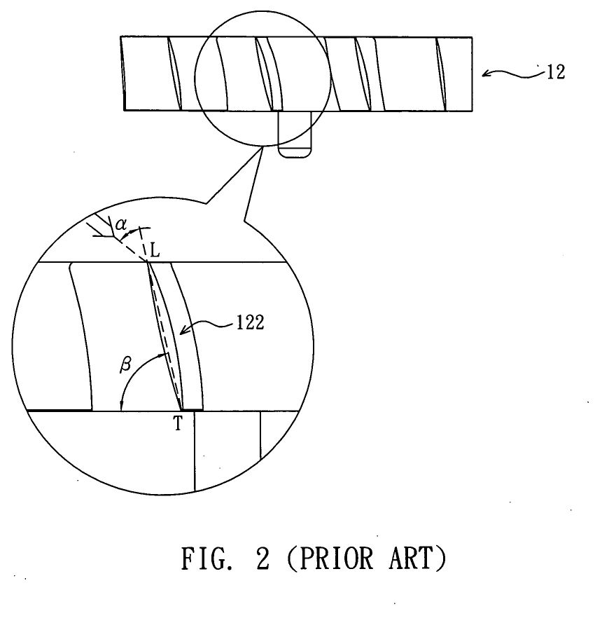

### DETAILED DESCRIPTION OF THE INVENTION

The present invention will be apparent from the following detailed description, which proceeds with reference to the accompanying drawings, wherein the same references relate to the same elements.

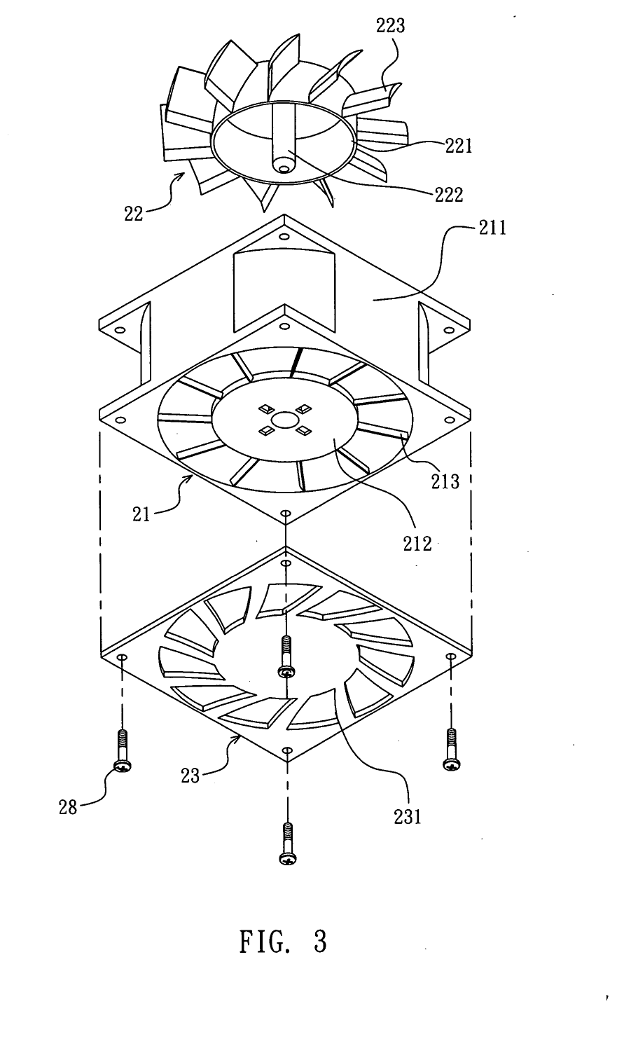

As shown in FIG. 3, a fan 2 according to a first embodiment of the present invention includes a frame 21 and an impeller 22.

The frame 21 has a shell 211 and a base 212 inside. A plurality of stationary blades 213 or ribs are connected between the shell 211 and the base 212. In addition, a motor (not shown) may be disposed in the base 212.

The impeller 22 has a hub 221 and a plurality of blades 223 disposed around the hub 221. The hub 221 has a shaft 222 pivoted in the base 212 of the frame 21. The impeller 22 is driven by the motor to rotate.

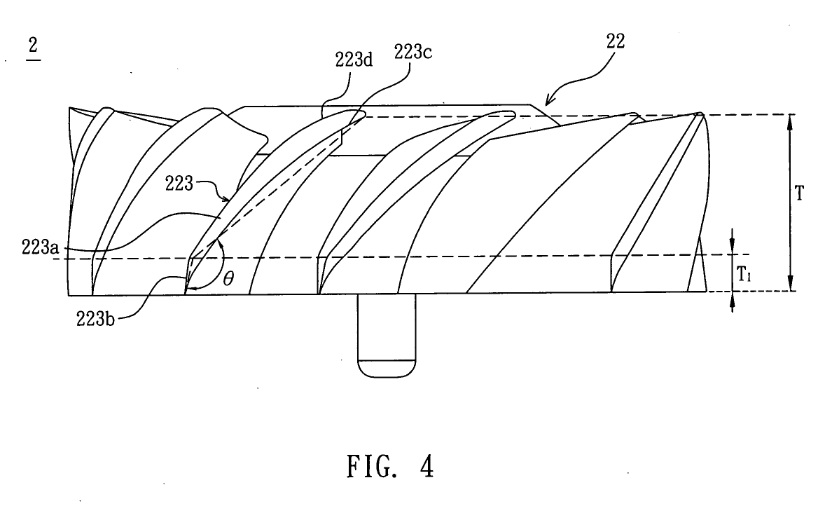

As shown in FIG. 4, each blade 223 has a wing part 223a and a flap part 223b, wherein the flap part 223b is as the extended part of the wing part 223a and the extended direction of the flap part 223b is different from that of the wing part 223a. The wing part 223a and the flap part 223b can be formed a complete wing. Each blade 223 has a front surface 223c and a back surface 223d. A predetermined angle θ is formed by the wing part 223a and the flap part 223b at the position of the front surface 223c. In this embodiment, the predetermined angle θ is greater than 90 degrees. The ratio of the axial length T₁ of the flap parts 223b to the axial length T of the blades 223 is less than 0.75. The flap part 223b is for example curved or flat.

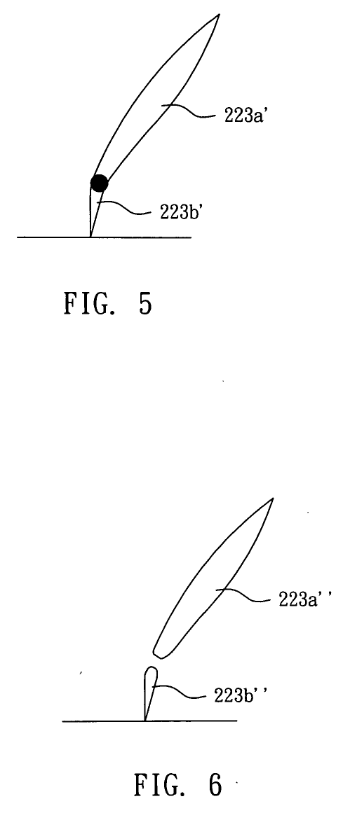

In this embodiment, the wing part 223a and the flap part 223b of each blade 223 are integrally formed as a single piece. Of course, the wing part 223a and the flap part 223b may also be provided separately. The connection between the wing part 223a and the flap part 223b may be touch connection, adhesive connection, pivotal connection, or adjacent connection. As shown in FIG. 5, the flap part 223b′ is pivoted at one end of the wing part 223a′. Alternatively, as shown in FIG. 6, the flap part 223b″ and the wing part 223a″ are disposed apart from each other at a distance. Of course, the flap part may be directly in touch against one end of the wing part. It should be noted that the shapes of the wing part and the flap part are not limited in the present invention. The wing part and the flap part may have different shapes, different installation-angles. Alternatively, the front surface 223c of the blade formed by the wing part and the flap part may be a discontinuous plane or curved surface.

With further reference to FIG. 3, the fan 2 further includes a protecting cover 23 with a plurality of ribs 231. The protecting cover 23 can be locked on the frame 21 by four screws 28.

Practical test results show that, when the same motor provides the same rotating speed, the fan 2 has better airflow efficiency and delay the occurrence of stalling phenomenon in comparison with the conventional fan 1 at the same noise value and the same power consumption.

In addition to applications to the impeller 22, the structure of the wing part 223a and the flap part 223b may be used in other parts of the fan too.

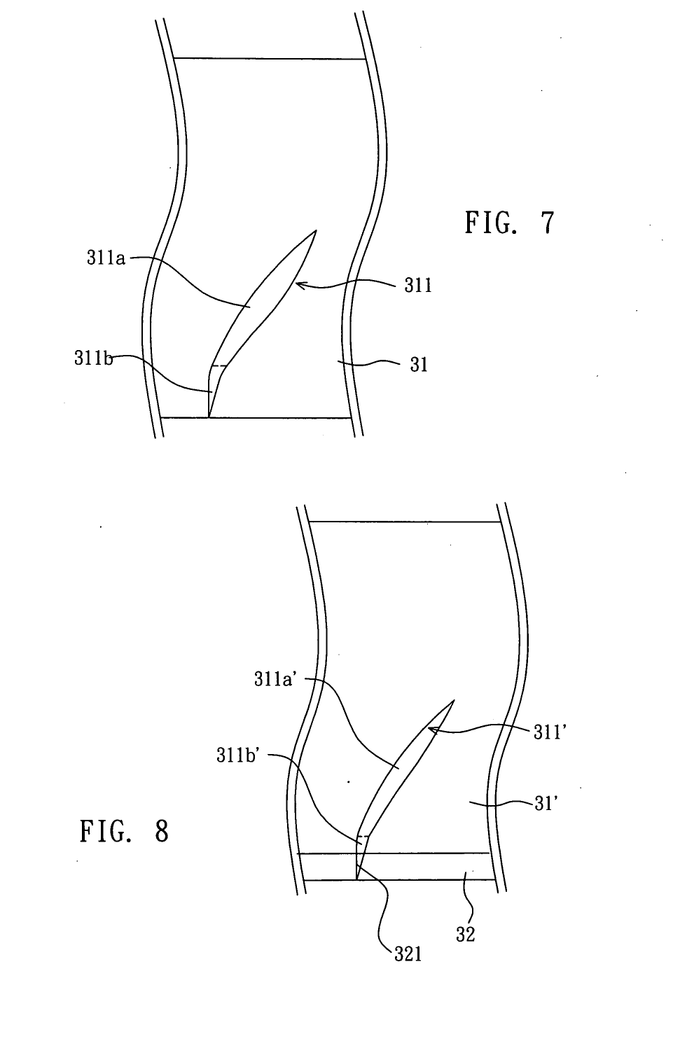

As shown in FIG. 7, a fan 3 according to a second embodiment of the present invention has a frame 31 and an impeller (not shown) disposed in the frame 31. The frame 31 has a plurality of stationary blades 311, each of the stationary blades 311 has a wing part 311a and a first flap part 311b. The structure of the wing part 311a and the first flap part 311b has the same constructions and functions as those in the first embodiment. Therefore, they are not further described herein.

As shown in FIG. 8, the fan 3 further includes a protecting cover 32 connected to the frame 31′. In this embodiment, the frame 31 has a wing part 311a′ and a first flap part 311b′ as those in FIG. 7, the protecting cover 32 further has a plurality of second flap parts 321, each of the second flap parts 321 is a rib of the protecting cover 32. Each of the second flap parts 321 is disposed corresponding to the first flap part 311b′. The first flap part 311b′ together with the second flap part 321 form a complete wing. Moreover, the connection between the wing part 311a′, the first flap part 311b′ and the second flap part 321 may be touch connection, adhesive connection, pivotal connection, adjacent connection, or disposed apart from each other at a distance.

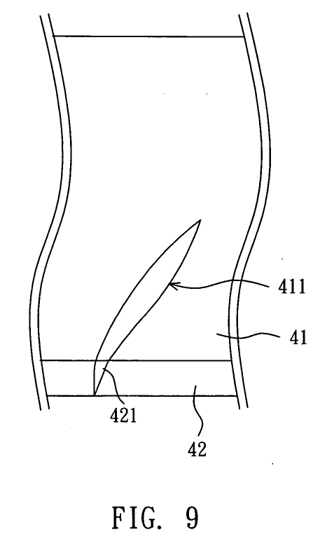

As shown in FIG. 9, a fan 4 according to a third embodiment of the present invention includes a frame 41, an impeller (not shown) disposed in the frame 41, and a protecting cover 42 connected to the frame 41. The frame 41 has a plurality of wing parts 411, each of the wing parts 411 is the stationary blade of the frame 41. The protecting cover 42 has a plurality of flap parts 421, each of the flap parts 421 is a rib of the protecting cover 42. Therefore, once the protecting cover 42 is combined with the frame 41, the wing parts 411 are respectively disposed corresponding to the flap parts 421. Likewise, the connection between the wing part 411 and the flap part 421 may be touch connection, adhesive connection, pivotal connection, or adjacent connection.

Since the wing parts and the flap parts are respectively disposed on the frame or protecting cover, the airflow can be blown out more smoothly without affecting the airflow efficiency of the fan.

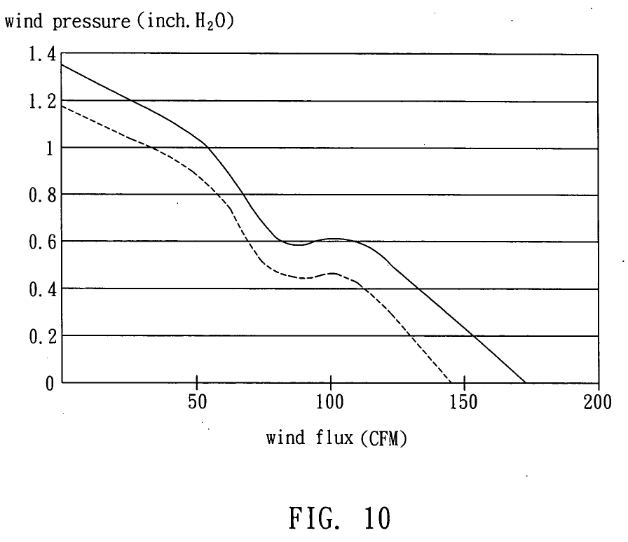

As shown in FIG. 10, the vertical axis indicates the wind pressure and the horizontal axis indicates the wind flux. The dashed line is the result of a conventional fan, and the solid line represents the fan according to the present invention. For the same wind flux, the fan according to the present invention has a larger wind pressure and increases the airflow efficiency by more than 5%.

The present invention also provides a fan blade including a wing part and a flap part. The flap part is connected to the wing part, and the wing part and the flap part form a predetermined angle.

In summary, due to the flap part is connected to the wing part, and the wing part and the flap part form a first predetermined angle. Comparing with the prior art, a fan and a blade thereof according to the present invention can enhance the airflow efficiency, prevent installing phenomenon from happening, and reduce the noises during operations. Moreover, in addition to the impeller of the fan, the structure of the wing part and the flap part can be disposed in the flame or protecting cover to enhance the airflow efficiency and the product quality.

Although the present invention has been described with reference to specific embodiments, this description is not meant to be construed in a limiting sense. Various modifications of the disclosed embodiments, as well as alternative embodiments, will be apparent to persons skilled in the art. It, is, therefore, contemplated that the appended claims will cover all modifications that fall within the true scope of the present invention.

What is claimed is:

1. A fan comprising:
an impeller having a plurality of blades, wherein each blade has a first wing part and a first flap part, and the first wing part and the first flap part form a first predetermined angle.

2. The fan according to claim 1, wherein the first wing part and the first flap part are integrally formed as a single piece or disposed apart from each other at a distance.

3. The fan according to claim 1, wherein the connection between the first wing part and the first flap part is touch connection, adhesive connection, pivotal connection or adjacent connection.

4. The fan according to claim 1, wherein the shapes or the installation-angles of the first wing part and the first flap part are different.

5. The fan according to claim 1, further comprising a frame, wherein the impeller is disposed in the frame, and the frame has a plurality of stationary blades connected to the frame.

6. The fan according to claim 5, wherein the stationary blade has a second wing part and a second flap part, and the second wing part and the second flap part form a second predetermined angle.

7. The fan according to claim 6, wherein the shapes or the installation-angles of the second wing part and the second flap part are different.

8. The fan according to claim 6, further comprising a protecting cover connected to the frame, wherein the protecting cover has a plurality of third flap parts respectively corresponding to the second flap parts to form a complete wing.

9. A fan comprising:
a frame having a plurality of stationary blades, wherein each stationary blade has a wing part and a first flap part, and the wing part and the first flap part form a predetermined angle; and
an impeller disposed in the frame.

10. The fan according to claim 9, further comprising a protecting cover connected to the frame, wherein the protecting cover has a plurality of second flap parts respectively corresponding to the first flap parts to form a complete wing.

11. The fan according to claim 10, wherein the shape of the complete wing is curved or flat.

12. The fan according to claim 10, wherein the shapes or the installation-angles of the wing part and the complete wing are different.

13. The fan according to claim 9, wherein the stationary blade further comprises a front surface that is a discontinuous plane or curved surface.

14. The fan according to claim 9, wherein the shapes or the installation-angles of the wing part and the first flap part are different.

15. A fan comprising:
a frame having a plurality of wing parts;
an impeller disposed in the frame; and
a protecting cover connected to the frame and having a plurality of flap parts respectively corresponding to the wing parts, wherein the wing part and the flap part form a predetermined angle.

16. The fan according to claim 15, wherein the wing part and the flap part form a blade with a front surface that is a discontinuous plane or curved surface.

17. The fan according to claim 15, wherein the shapes or the installation-angles of the wing part and the flap part are different.

18. A fan comprising:
a frame having a plurality of first flap parts; and
an impeller disposed in the frame and having a plurality of wing parts, wherein the wing part and the first flap part form a predetermined angle.

19. The fan according to claim 18, wherein the shapes or the installation-angles of the wing part and the first flap part are different.

20. The fan according to claim 18, further comprising a protecting cover connected to the frame, wherein the protecting cover has a plurality of second flap parts respectively corresponding to the first flap parts to form a complete wing.
